(19) United States
(12) Patent Application Publication
(10) Pub. No.: US 2020/0065668 A1
(43) Pub. Date: Feb. 27, 2020

(54) METHOD AND SYSTEM FOR LEARNING SEQUENCE ENCODERS FOR TEMPORAL KNOWLEDGE GRAPH COMPLETION

(71) Applicant: NEC Laboratories Europe GmbH, Heidelberg (DE)

(72) Inventors: Alberto Garcia Duran, Heidelberg (DE); Mathias Niepert, Heidelberg (DE)

(21) Appl. No.: 16/113,089

(22) Filed: Aug. 27, 2018

(51) Int. Cl. G06N 3/08; G06N 5/02

(52) U.S. Cl. CPC G06N 3/08; G06N 5/02

(57) ABSTRACT

A method of incorporating temporal information into a knowledge graph comprising triples in a form of subject, predicate and object for link prediction, includes the step of determining, for each of the triples, a predicate sequence including a concatenation of a predicate token and, for the triples having the temporal information available, a sequence of temporal tokens, the predicate tokens including at least a relation type token. The predicate sequences are input to a recursive neural network so as to learn representations of the predicate sequences which carry the temporal information. The learned representations of the predicate sequences are used along with embeddings of the subjects and objects in a scoring function for the link prediction.

### FIELD

The present invention relates to generally to ontology or knowledge graphs (KGs), and more particularly to a method and system to incorporate temporal information for link prediction.

### BACKGROUND

Ontologies are used in a number of domains to organize information using relational data, which can then be used for problem solving in the respective domain. KGs organize information which has been structured using the relational data in a manner which allows the structured information to be retrieved and managed. KGs are in the form G=(E,R), where E is a set of entities and R is a set of relations or predicates. Traditional KGs represent information G as a set of triples of the form (subject, predicate, object), also denoted as (s, p, o). Most real-world KGs are incomplete due to missing relational data between the entities.

### SUMMARY

In an embodiment, the present invention provides a method of incorporating temporal information into a knowledge graph comprising triples in a form of subject, predicate and object for link prediction. The method includes the step of determining, for each of the triples, a predicate sequence including a concatenation of a predicate token and, for the triples having the temporal information available, a sequence of temporal tokens, the predicate tokens including at least a relation type token. The predicate sequences are input to a recursive neural network so as to learn representations of the predicate sequences which carry the temporal information. The learned representations of the predicate sequences are used along with embeddings of the subjects and objects in a scoring function for the link prediction.

### BRIEF DESCRIPTION OF THE DRAWINGS

The present invention will be described in even greater detail below based on the exemplary figures. The invention is not limited to the exemplary embodiments. All features described and/or illustrated herein can be used alone or combined in different combinations in embodiments of the invention. The features and advantages of various embodiments of the present invention will become apparent by reading the following detailed description with reference to the attached drawings which illustrate the following:

FIG. 1 is a schematic view of an example of a temporal KG;

FIG. 2 is an example of different temporal tokens for day, month and year;

FIG. 3 shows the formation of a predicate sequence including temporal tokens and a relation type token; and

FIG. 4 is a schematic view of an example of a company graph as a temporal KG.

### DETAILED DESCRIPTION

Embodiments of the present invention provide for KG completion and address the link prediction problem in temporal multi-relational data by learning latent entity and relation type representations. Recurrent neural networks are used to learn the relation type representations that may carry temporal information, which can be used in conjunction with existing latent factorization methods.

The link prediction problem seeks the most probable completion of a triple (subject, predicate, ?) or (?, predicate, object) or (subject, ?, object). Embodiments of the present invention apply, in particular, to temporal KGs having the form G=(E,R,T), where T is a set of temporal information. In temporal KGs, some triples are augmented with temporal information such that the temporal KGs represent information G as a set of triples with timestamp information, where available, for example, in the form (subject, predicate, object, timestamp) or (subject, predicate, object time predicate, timestamp), in addition to the (subject, predicate, object) triples.

Examples of such information include (Barack Obama, bornIn, USA, 1961), (Barack Obama, president, USA, since, 2009-01) or (NLE, became, NEC GmbH, occursSince, 2018). Embodiments of the present invention use the temporal information in order to complete time-enriched queries such as (?, bornIn, USA, 1961) or (?, president, USA, occursSince, 2009-01). In other words, the link prediction problem is solved according to embodiments of the present invention by providing the most probable completion using the temporal information. Moreover, embodiments of the present invention are able to incorporate the temporal information into standard embedding approaches for link prediction, and in doing so are also able to resolve heterogeneity of time expressions due to variations in language and serialization standards. For example, one may have timestamps YYYY/MM/DD for some facts, whereas for others only information regarding the year YYYY is available. Thus, the available timestamps can have different granularity. It is assumed according to an embodiment that time expressions are represented from coarse to finer granularity (YYYY/MM/DD/HH/MM/SS). If the format is different (e.g., MM/YYYY), then in a pre-processing step, the terms are rearranged to the format from coarse to finer granularity.

In an embodiment, a method of incorporating temporal information into a KG comprising triples in a form of subject, predicate and object for link prediction is provided, the method comprising:

determining, for each of the triples, a predicate sequence including a concatenation of a predicate token and, for the triples having the temporal information available, a sequence of temporal tokens, the predicate tokens including at least a relation type token;

inputting the predicate sequences into a recursive neural network so as to learn representations of the predicate sequences which carry the temporal information; and

using the learned representations of the predicate sequences with embeddings of the subjects and objects in a scoring function for the link prediction.

In the same or a different embodiment, at least some of the predicate tokens include a temporal modifier token and the temporal modifier token in combination with the temporal tokens indicates a temporal range applicable to the relation type token.

In the same or a different embodiment, the scoring function is TransE or distMult.

In the same or a different embodiment, the recursive neural network is a long short-term memory network.

In the same or a different embodiment, each of the representations of the predicate sequences is determined from a last hidden state of the recursive neural network.

In the same or a different embodiment, each token of the predicate sequence is mapped to an embedding via a linear layer so as to generate a sequence of embeddings which is used as input to the recursive neural network.

In the same or a different embodiment, the temporal information is only available for some of the triples, the method further comprising framing the temporal information in a same relative time system.

In the same or a different embodiment, wherein the temporal tokens have a vocabulary size of 32.

In the same or a different embodiment, the KG is based on a company graph, and the link prediction is performed to complete a query directed to predicting which of the subjects have performed a transaction for a particular one of the objects representing a company at a predetermined time or range of times.

In the same or a different embodiment, the KG is based on criminal records, and the link prediction is performed to complete a query directed to predicting which of the subjects have committed a crime in a particular one of the objects representing geographical areas at a predetermined time or range of times, or to complete a query directed to predicting which of the objects representing the geographical areas are most likely to see criminal activity by a particular one of the subjects at a predetermined time or range of times.

In the same or a different embodiment, the KG is based on information taken from a sensor integrated management system, and the link prediction is performed to complete a query directed to predicting which of the subjects representing a component of the system have performed a communication for a particular one of the objects at a predetermined time or range of times.

In an embodiment, a system for incorporating temporal information into a KG comprising triples in a form of subject, predicate and object for link prediction, is provided, the system comprising one or more computer processors which, alone or in combination, are configured to provide for execution of the following steps:

determining, for each of the triples, a predicate sequence including a concatenation of a predicate token and, for the triples having the temporal information available, a sequence of temporal tokens, the predicate tokens including at least a relation type token;

inputting the predicate sequences into a recursive neural network so as to learn representations of the predicate sequences which carry the temporal information; and

using the learned representations of the predicate sequences with embeddings of the subjects and objects in a scoring function for the link prediction.

In the same or a different embodiment, at least some of the predicate tokens include a temporal modifier token.

In an embodiment, a tangible, non-transitory computer-readable medium is provided having instructions thereon which, when executed on one or more processors, provide for execution of a method of incorporating temporal information into a knowledge graph comprising triples in a form of subject, predicate and object for link prediction, the method comprising:

determining, for each of the triples, a predicate sequence including a concatenation of a predicate token and, for the triples having the temporal information available, a sequence of temporal tokens, the predicate tokens including at least a relation type token;

inputting the predicate sequences into a recursive neural network so as to learn representations of the predicate sequences which carry the temporal information; and

using the learned representations of the predicate sequences with embeddings of the subjects and objects in a scoring function for the link prediction.

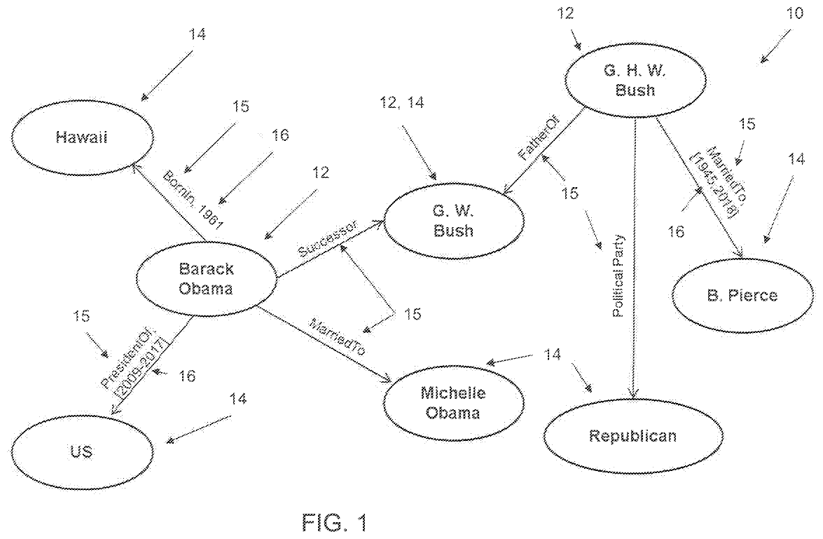

FIG. 1 schematically shows an exemplary temporal KG 10, wherein the subjects 12 and objects 14 are indicated in circles interconnected by predicates 15, supplemented in some cases by timestamp information 16.

There are embedding approaches for KG completion that learn a scoring function f that operates on the embeddings of the subject eₛ, the object eₒ, and the predicate eₚ of the triples. The value of this scoring function on a triple (s, p, o), f(s,p,o), is learned to be proportional to the likelihood of the triples being true.

Examples of such scoring functions include:

f(s,p,o)=∥eₛ+eₚ−eₒ∥₂ TransE:

f(s,p,o)(eₛ*eₒ)eₚ^{T} distMult:

wherein T is the transpose of the vector,
where eₛ, eₒϵR^{d} are the embeddings of the subject and object entities, eₚϵR^{d} is the embedding of the relation type predicate, and * indicates the element-wise product, and wherein ϵR^{d} represents the dimensionality of the set of latent representations (embeddings).

These scoring functions do not take temporal information into account. Further information on the TransE scoring function can be found in Leblay, J., et al., “Deriving Validity Time in Knowledge Graph,” In Companion of the Web Conference 2018, International World Wide Web Conferences Steering Committee, pp 1771-1776 (April 2018), which is hereby incorporate by reference herein. Further information on the distMult scoring function can be found in Trivedi, R., et al., “Know-evolve: Deep temporal reasoning for dynamic knowledge graphs,” In International Conference on Machine Learning, pp. 3462-3471 (July 2017), which is also hereby incorporated by reference herein.

As mentioned above, the sparsity of temporal information and the irregularity of time expressions are problems that make it challenging to learn representations that carry temporal information. Embodiments of the present invention solve these problems by converting the time expressions into sequences of tokens expressing the temporal information in a standard way, despite possibly differing standards and formats of the time expressions. Moreover, character-level architectures for language modeling can operate on characters as atomic units to learn word embeddings.

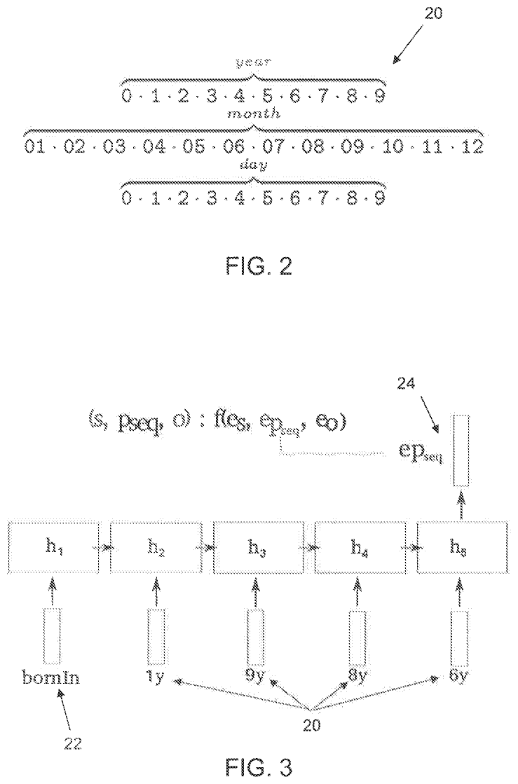

Thus, it is possible according to embodiments of the present invention, given a temporal KG where some triples are augmented with temporal information, to decompose a given (possibly incomplete and/or irregular) timestamp into a sequence consisting of some of the temporal tokens 20 shown in FIG. 2. These temporal tokens 20 have a vocabulary size of 32 as, in this case, each token is one out of 32 possibilities (12 months, 10 digits corresponding to years, and 10 digits corresponding to days). Years are represented with four tokens and days with two tokens. Moreover, for each triple, a sequence of predicate tokens can be extracted that always consists of the relation type token and, if available, a temporal modifier token such as “since” or “until.” The concatenation of the predicate token sequence and, if available, the sequence of temporal tokens is referred to herein as the predicate sequence p_{seq}. The size of the temporal modifier token depends on the data set, or the amount of modifier tokens used. In an embodiment, there are at least two tokens for the modifier tokens (one corresponding to “since”, and a second corresponding to “until”). The modifier tokens advantageously allow to embed representations of time intervals.

According to embodiments of the present invention, a temporal KG can then represent facts as a collection of triples of the form (s, p_{seq}, o), wherein the predicate sequence p_{seq} may include temporal information. Table 1 lists some examples of such facts from a temporal KG and their corresponding predicate sequence. The suffixes y, m and d indicate whether the digit corresponds to year, month or day information, respectively. It is these sequences of tokens that are used as input to a recurrent neural network.

TABLE 1

| Fact | Predicate Sequence |
|---|---|
| (Barack Obama, country, USA) | [country] |
| (Barack Obama, bornIn, USA, 1961) | [bornIn, 1y, 9y, 6y, 1y] |
| (Barack Obama, president, USA, | [president, since, 2y, 0y, 0y, |
| since, 2009-01) | 09y, 01m] |

A long short-term memory (LSTM) is a neural network architecture particularly suited for modeling sequential data. The functions defining an LSTM are:

i=σ_{g}(hₙ₋₁Uᵢ+xₙWᵢ)

f=σ_{g}(hₙ₋₁U_{f}+xₙW_{f})

o=σ_{g}(hₙ₋₁Uₒ+xₙWₒ)

g=σ_{gc}(hₙ₋₁U_{g}+xₙW_{g})

cₙ=f*cₙ₋₁+i*g

hₙ=o*σh(cₙ)

wherein i, f, o and g are the input, forget, output and input modulation gates, respectively, c and h are the cell and hidden state, respectively, wherein according to an embodiment h=d, wherein d is the dimensionality of the embeddings), and wherein * again indicates the element-wise product. The U and W matrices are parameters of the LSTM that are learned. All vectors are in R^{h}. xₙϵR^{d} is the representation of the n-th element of a sequence. σ_{g}, σₒ and σₕ are activation functions.

Each token of the input sequence p_{seq} is first mapped to its corresponding d-dimensional embedding via a linear layer. Starting from the predicate sequence, each of the elements is mapped to their embedding (e.g., the model learns a representation for January, a representation for the digit 1 when it refers to year information and so on). Each token is associated to one embedding. For a certain predicate sequence, the LSTM learns a representation/embedding that contains information regarding all elements of the predicate sequence. The resulting sequence of embeddings is used as input to the LSTM. Each predicate sequence of length N is represented by the last hidden state of the LSTM, that is, e_{pseq}=h_{N}. The predicate sequence representation, which carries temporal information, can now be used in conjunction with subject and object embeddings in standard scoring functions.

For example, embodiments of the present invention thereby provide time-aware versions of TransE and distMult, referred to herein as TA-TransE and TA-distMult, have the following scoring function for triples (s, p_{seq}, o):

f(s,p_{seq},o)=∥eₛ+e_{pseq}−eₒ∥₂ TA-TransE:

f(s,p_{seq},o)=(eₛ*eₒ)e_{pseq}^{T} TA-distMult:

where * again indicates the element-wise product.

All parameters of the scoring functions are learned jointly with the parameters of the LSTMs using stochastic gradient descent. According to an embodiment, the learning consists of: the learning of the embeddings of the tokens that are part of the predicate sequences, the learning of the parameters of the LSTM, and the learning of the remaining parameters of the scoring function (i.e., embeddings of the entities). All are learned to maximize the scores of the observed facts (examples of such facts are in Table 1).

The advantages of the character-level/digit-level models to encode time information for link prediction include: (1) the usage of digits and modifiers such as “since” or “until” as atomic tokens (e.g., the predicate sequence contains a sequence of tokens: the relationships plus, if they exist, temporal modifier tokens (e.g. since, until) and temporal tokens (coming from the vocabulary of size 32)) which facilitates the transfer of information across similar timestamps, leading to higher efficiency (e.g. small vocabulary size); (2) at test time, one can obtain a representation for a timestamp even though it is not part of the training set; (3) the model can use triples with and without temporal information as training data. FIG. 3 illustrates how the sequence of tokens including a relation type token 22 and the temporal tokens 20 is provided as the sequence 24 used as e_{pseq} in accordance with an embodiment of the present invention. According to an embodiment, a standard token sequence, such as relation type token, followed by temporal modifier token, if it is available, followed by temporal tokens of increasing granularity is selected and used consistently. h1-h5 represent the hidden states of the LSTM. The input to the LSTM is the sequence of embeddings e_{pseq} coming from the predicate sequence. The LSTM processes all this information, one by one, and in the end it outputs the last hidden state, which contains information regarding all elements of the predicate sequence. That last hidden state is then used in the chosen scoring function f.

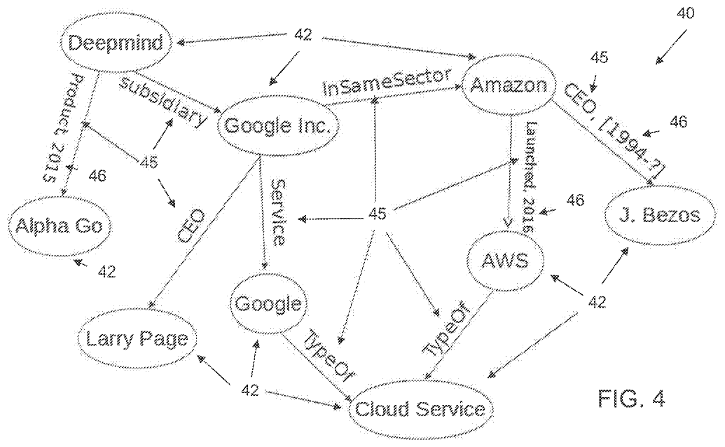

FIG. 4 shows a company graph as a temporal KG 40 for companies and financial data which is a multi-relational graph that contains relationships 45 between entities 42 such as instances of companies, products or individuals. Common relationships 45 that one can find in such a KG 40 are those that express collaborations or transactions between companies or bids made by companies or individuals for products. Temporal information 46 is often available for use in company graphs. For example, collaborations, transactions and bids occurred either at a specific point in time or in a time interval.

According to an embodiment of the present invention, time-aware representations are learned that allow to cluster entities with similar temporal behavior. Moreover, it is also possible in accordance with an embodiment of the present invention to complete queries for the KG 40 that contain time information. For example, one query which would be especially enhanced by an embodiment of the present invention would be a query that aims to detect (illegal) insider trading that happened at a specific point in the past or that may happen in the near future. Take for example a KG wherein some information about insider tradings that happened in the past is known and represented along with information about transactions and other relationships across different entities of the KG. All this information is framed in time. One example of a query in this embodiment to more accurately predict/detect insider trading by using embedded temporal information is (?, commit, insider_trading, 2014).

Another embodiment of the present invention can be applied to enhance public safety. Public safety is another domain in which temporal information is of relevance. For example, criminal records can be represented as a multi-relational graph or temporal KG with relationships that express the type of crime, the weapon used to commit a certain crime, the location of the crime or the neighborhood of tracked individuals. Most of this information can be framed in time.

The completion of queries can therefore benefit from the inclusion of temporal information. For example, one may be interested in shortlisting individuals that potentially committed a crime in a certain neighborhood at a specific point of time One example of a query in this embodiment to more accurately identify such individuals by using embedded temporal information is (?, commited_burglary_in, Heidelberg, between 2010-2015). Scoring functions operating on time-aware representations would give higher confidence to individuals who committed similar crimes in the past and were living in that neighborhood at the given time.

Embodiments of the present invention can be used for sensor integrated management by extracting facts from different systems and linking them to a KG. These systems collect information, for example, about human sources, ships, planes, industrial activities, etc. An example of a fact one may find in the KG is (satellite_X, communicate, plane_Z, 2015/01/24) or (ship_X, entered, Chinese_waters, 2010-2012). One example of a query in this embodiment to more accurately manage the systems by using embedded temporal information is (satellite_x, communicate, ?, 2018/01/05). Some of these systems are IMINT (Imagery Intelligence), SIGINT (Signals Intelligence) or OSINT (Open-Source Intelligence).

The resulting KG, wherein temporal information is available for a number of facts, is used for several tasks, e.g. search, visualization, reasoning. These tasks would benefit from having a more complete knowledge graph. Therefore, the system would be significantly improved by the mechanism for KG completion that can incorporate temporal information.

According to an embodiment, the present invention provides improvements and advantages through a method to learn time-aware representations by making use of a recurrent neural network for time-encoding sequences. The recurrent neural network is fed with a sequence that contains the relation type and, if available, time information such as temporal modifiers and/or temporal tokens. As a further advantage, the mechanism to learn-time aware representations can be used in conjunction with most of the existing scoring functions.

The method according to an embodiment, given a temporal KG where some triples are augmented with temporal information, comprises the following steps:
The temporal information is framed into the same relative system (e.g., Gregorian calendar).
For each triple, the predicate sequence having the concatenation of the predicate tokens and (if available) the sequence of temporal tokens is determined. The predicate tokens consist of the relation type token and, if available, a temporal modifier token such as “since” or “until”.
A scoring function is chosen. The selection is limited to scoring functions that model predicates as vectors. Examples of such scoring functions are TransE or distMult.
The LSTM learns a latent representation/embedding from the predicate sequence as input, which is used in the chosen scoring function.

Jiang, T., Liu, et al., “Towards Time-Aware Knowledge Graph Completion,” In Proceedings of COLING 2016, the 26th International Conference on Computational Linguistics: Technical Papers, pp. 1715-1724 (2016) and Esteban, C., et al., “Predicting the co-evolution of event and knowledge graphs,” In Information Fusion (FUSION), 19th International Conference, pp. 98-105 (July 2016), each of which are hereby incorporated by reference herein, are two works in the area of KGs. These works, however, are limited to settings where all facts contain time information and the level of granularity of this information is the same for all facts. A further limitation of these works is that time information always has to refer to a specific point in time, and as a consequence, they cannot deal with intervals of time. The works cited above with respect to the scoring functions TransE and distMult suffer from the same limitations. Advantages of embodiments of the present invention with respect to these works include:

1) The usage of digits as atomic tokens. The tokens are mapped to their embeddings, which in turn are used as input to the LSTM. The output of the LSTM (last hidden state) is used in the scoring function to facilitate the transfer of information across similar timestamps, leading to higher efficiency (e.g. small vocabulary size).
2) The usage of modifiers such as “since” or “until” allows to express time intervals.
3) The usage of digits as atomic tokens allows to obtain representations, at test time, for timestamps even though are not part of the training set.
4) The model works with triples with and without temporal information.
5) The model can use time-enriched triples whose level granularity varies across facts. For example, some facts may be framed in a specific year, month and day, whereas for others only information regarding the year is available.
6) The model can encode temporal information that corresponds to a period of time, and not only to a specific point in time.

The improvements provided by the present invention have been empirically demonstrated on three different temporal knowledge graphs with two different scoring functions. These improvements include a higher accuracy with respect to other approaches that take temporal information into account, and also to others that do not. Accordingly, embodiments of the present invention, in addition to being able to learn time-aware representations, also results in more efficient computation of queries and a more accurate link prediction.

Integrated Crisis Early Warning System (ICEWS) is a repository that contains a KG of political events with a specific timestamp. The repository is organized in dumps that contain the events that occurred each year from 1995 to 2015. Two temporal KGs were created out of this repository: i) a short-range version that contains all events in 2014 (ICEWS '14), and ii) a long-range versions that contains all events occurring between 2005-2015 (ICEWS 2005-15). Due to the large number of entities, a subset of the most frequently occurring entities in the graph was selected and all facts were used where both the subject and object are part of this subset of entities. To create a third temporal KG, referred to herein as YAGO15K, FREEBASE15K (see Bordes, A. et al., “Translating embeddings for modeling multi-relational data,” In Advances in neural information processing systems, pp. 2787-2795 (2013)) was used as a blueprint and the entities were aligned from FREEBASE15K to YAGO (see Hoffart, J. et al., “Yago2: A spatially and temporally enhanced knowledge base from wikipedia,” Artificial Intelligence, 194:28-61 (2013)) with SAMEAS relations contained in the YAGO dump(/yago-naga/yago3.1/yagoDBpedialnstances.ttl.7z), and kept all facts involving those entities. Then, this collection of facts was supplemented with time information from the “yagoDateFacts” dump (/yago-naga/yago3.1/yagoDateFacts.ttl.7z). Table 2 below lists some statistics of the temporal KGs. TS stands for timestamps. The number of facts with time information is in brackets.

TABLE 2

| Data set | YAGO15K | ICEWS ′14 | ICEWS 05-15 |
|---|---|---|---|
| Entities | 15,403 | 6,869 | 10,094 |
| Relationships | 34 | 230 | 251 |
| #Facts | 138,056 | 96,730 | 461,329 |
| #Distinct TS | 198 | 365 | 4,017 |
| Time Span | 1513-2017 | 2014 | 2005-2015 |
| Training | 110,441 | 78,826 | 368,962 |
| | [29,381] | [78,826] | [368,962] |
| Validation | 13,815 | 8,941 | 46,275 |
| | [3,635] | [8,941] | [46,275] |
| Test | 13,800 | 8,963 | 46,092 |
| | [3,685] | [8,963] | [46,092] |

The various methods were evaluated by their ability to answer completion queries where i) all the arguments of a fact are known except the subject entity, and ii) all the arguments of a fact are known except the object entity. For the former, the subject was replaced by each of the KG's entities E in turn, the triples were sorted based on the scores returned by the different methods and the rank of the correct entity was computed. The same process was repeated for the objects in the second completion task and the results were averaged. The filtered setting as described in Bordes, A. et al. is also reported. The mean of all computed ranks is the mean rank (MR), wherein a lower value for MR is better, and the fraction of correct entities ranked in the top n is called hits@n, wherein a higher value for hits@n is better. The mean reciprocal rank (MRR) was also computed, wherein a higher value for MRR is better. The MRR is less susceptible to outliers. Leblay, J. et al. evaluates different approaches for performing link prediction in temporal KGs. The approach referred to in Table 3 below as TTransE learns independent representations for each timestamp and uses these representations as translation vectors (see also Bordes et al.). This approach achieves better results than the scoring functions TransE and distMult alone. Table 3 compares the time aware versions of the scoring functions according to embodiments of the present invention, TA-TransE and TA-distMult, against TTRANSE, and against the scoring functions TransE and distMult as standard embedding methods. For all approaches, ADAM (see Kingma, D. et al. “Adam: A method for stochastic optimization,” arXiv preprint arXiv: 1412.6980 (2014)) was used as the function for parameter learning in a mini-batch setting with a learning rate of 0.001, the categorical cross-entropy (see Kadlec, R. et al., “Knowledge base completion: Baseline strike back, arXiv preprint ArXiv: 1705.10744 (2017)) was used as loss function and the number of epochs was set to 500. Every 20 epochs were validated and learning was stopped whenever the MRR values on the validation set decreased. The batch size was set to 512 and the number of negative samples was set to 500 for all experiments. The embedding size was d=100. Dropout (see Srivastava, N. et al., “Dropout: A simple way to prevent neural networks from overfitting,” The Journal of Machine Learning Research, 15(1):1929-1958 (2014)) was applied for all embeddings. The dropout from the values {0, 0.4} was validated for all experiments. For TA-TransE and TA-distMult, the activation gate as is the sigmoid function, and σ_{c} and σₕ were chosen to be linear activation functions.

Table 3 lists the results for the KG completion tasks. TA-TransE and TA-distMult were shown to systematically improve TransE and distMult in MRR, MR, hits@10 and hits@® in almost all cases. TTransE learns independent representations for each timestamp contained in the training set. At test time, timestamps unseen during training are represented by null vectors. For this reason, TTransE is only competitive in YAGO15K, wherein the number of distinct timestamps is very small (see # Distinct TS in Table 2) and thus enough training examples exist to learn robust timestamp embeddings. Even in this setting, however, TTransE is outperformed by TA-TransE and TA-distMult. Table 3 below shows the results (filtered setting) for the temporal KG completion task.

TABLE 3

| | YAGO15K | | | | ICEWS 2014 | | | | ICEWS 2005-15 | | | |
|---|---|---|---|---|---|---|---|---|---|---|---|---|
| | MRR | MR | Hits@10 | Hits@1 | MRR | MR | Hits@10 | Hits@1 | MRR | MR | Hits@10 | Hits@1 |
| TTrasnE | 32.1 | 578 | 51.0 | 23.0 | 25.5 | 148 | 60.1 | 7.4 | 27.1 | 181 | 61.6 | 8.4 |
| TTrasnE | 29.6 | 614 | 46.8 | 22.8 | 28.0 | 122 | 63.7 | 9.4 | 29.4 | 84 | 66.3 | 9.0 |
| distMult | 27.5 | 578 | 43.8 | 21.5 | 43.9 | 189 | 67.2 | 32.3 | 45.6 | 90 | 69.1 | 33.7 |
| TA-TrasnE | 32.1 | 564 | 51.2 | 23.1 | 27.5 | 128 | 62.5 | 9.5 | 29.9 | 79 | 66.8 | 9.6 |
| TA-distMult | 29.1 | 551 | 47.6 | 21.6 | 47.7 | 276 | 68.6 | 36.3 | 47.4 | 98 | 72.8 | 34.6 |

Thus, embodiments of the present invention provide a digit-level LSTM to learn representations for time-augmented KG facts that can be used in conjunction with existing scoring functions to link prediction.

While the invention has been illustrated and described in detail in the drawings and foregoing description, such illustration and description are to be considered illustrative or exemplary and not restrictive. It will be understood that changes and modifications may be made by those of ordinary skill within the scope of the following claims. In particular, the present invention covers further embodiments with any combination of features from different embodiments described above and below. Additionally, statements made herein characterizing the invention refer to an embodiment of the invention and not necessarily all embodiments.

The terms used in the claims should be construed to have the broadest reasonable interpretation consistent with the foregoing description. For example, the use of the article “a” or “the” in introducing an element should not be interpreted as being exclusive of a plurality of elements. Likewise, the recitation of “or” should be interpreted as being inclusive, such that the recitation of “A or B” is not exclusive of “A and B,” unless it is clear from the context or the foregoing description that only one of A and B is intended. Further, the recitation of “at least one of A, B and C” should be interpreted as one or more of a group of elements consisting of A, B and C, and should not be interpreted as requiring at least one of each of the listed elements A, B and C, regardless of whether A, B and C are related as categories or otherwise. Moreover, the recitation of “A, B and/or C” or “at least one of A, B or C” should be interpreted as including any singular entity from the listed elements, e.g., A, any subset from the listed elements, e.g., A and B, or the entire list of elements A, B and C.

What is claimed is:

1. A method of incorporating temporal information into a knowledge graph comprising triples in a form of subject, predicate and object for link prediction, the method comprising:
determining, for each of the triples, a predicate sequence including a concatenation of a predicate token and, for the triples having the temporal information available, a sequence of temporal tokens, the predicate tokens including at least a relation type token;
inputting the predicate sequences into a recursive neural network so as to learn representations of the predicate sequences which carry the temporal information; and
using the learned representations of the predicate sequences with embeddings of the subjects and objects in a scoring function for the link prediction.

2. The method according to claim 1, wherein at least some of the predicate tokens include a temporal modifier token.

3. The method according to claim 2, wherein the temporal modifier token in combination with the temporal tokens indicates a temporal range applicable to the relation type token.

4. The method according to claim 1, wherein the scoring function is TransE or distMult.

5. The method according to claim 1, wherein the recursive neural network is a long short-term memory network.

6. The method according to claim 1, wherein each of the representations of the predicate sequences is determined from a last hidden state of the recursive neural network.

7. The method according to claim 1, wherein each token of the predicate sequence is mapped to an embedding via a linear layer so as to generate a sequence of embeddings which is used as input to the recursive neural network.

8. The method according to claim 1, wherein the temporal information is only available for some of the triples, the method further comprising framing the temporal information in a same relative time system.

9. The method according to claim 1, wherein the temporal tokens have a vocabulary size of 32.

10. The method according to claim 1, wherein the knowledge graph is based on a company graph, and wherein the link prediction is performed to complete a query directed to predicting which of the subjects have performed a transaction for a particular one of the objects representing a company at a predetermined time or range of times.

11. The method according to claim 1, wherein the knowledge graph is based on criminal records, and wherein the link prediction is performed to complete a query directed to predicting which of the subjects have committed a crime in a particular one of the objects representing geographical areas at a predetermined time or range of times, or to complete a query directed to predicting which of the objects representing the geographical areas are most likely to see criminal activity by a particular one of the subjects at a predetermined time or range of times.

12. The method according to claim 1, wherein the knowledge graph is based on information taken from a sensor integrated management system, and wherein the link prediction is performed to complete a query directed to predicting which of the subjects representing a component of the system have performed a communication for a particular one of the objects at a predetermined time or range of times.

13. A system for incorporating temporal information into a knowledge graph comprising triples in a form of subject, predicate and object for link prediction, the system comprising one or more computer processors which, alone or in combination, are configured to provide for execution of the following steps:
determining, for each of the triples, a predicate sequence including a concatenation of a predicate token and, for the triples having the temporal information available, a sequence of temporal tokens, the predicate tokens including at least a relation type token;
inputting the predicate sequences into a recursive neural network so as to learn representations of the predicate sequences which carry the temporal information; and
using the learned representations of the predicate sequences with embeddings of the subjects and objects in a scoring function for the link prediction.

14. The system according to claim 13, wherein at least some of the predicate tokens include a temporal modifier token.

15. A tangible, non-transitory computer-readable medium having instructions thereon which, when executed on one or more processors, provide for execution of a method of incorporating temporal information into a knowledge graph comprising triples in a form of subject, predicate and object for link prediction, the method comprising:
determining, for each of the triples, a predicate sequence including a concatenation of a predicate token and, for the triples having the temporal information available, a sequence of temporal tokens, the predicate tokens including at least a relation type token;
inputting the predicate sequences into a recursive neural network so as to learn representations of the predicate sequences which carry the temporal information; and
using the learned representations of the predicate sequences with embeddings of the subjects and objects in a scoring function for the link prediction.
